(19) United States
(12) Patent Application Publication
(10) Pub. No.: US 2008/0256557 A1
(43) Pub. Date: Oct. 16, 2008

(54) Proactive Prevention of Service Level Degradation during Maintenance in a Clustered Computing Environment

(76) Inventors: German Goft, Pardes Hana Karkur (IL); Irit Goft, Pardes Hana Karkur (IL)

Correspondence Address: Suzanne Erez;IBM CORPORATION, Intellectual Property Law Dept., P.O. Box 218, Yorktown Heights, NY, 10598, US

(21) Appl. No.: 11/733,238

(22) Filed: Apr. 10, 2007

(51) Int. Cl. G06F 3/00

(52) U.S. Cl. 719/320

(57) ABSTRACT

A clustered computing environment with application staging, including a plurality of application instances running on at least one computer and operating in a clustered computing environment, and a stage manager operative to manage the transition of any of the application instances between a front stage assignment and a back stage assignment, where any of the application instances that are assigned as front stage application instances service requests, and where any of the application instances that are assigned as back stage application instances ceases to service requests and performs at least one maintenance task.

### FIELD OF THE INVENTION

The present invention relates to clustered computing environments in general, and in particular to maintenance therefor.

### BACKGROUND OF THE INVENTION

In a typical clustered computing environment multiple instances of the same application run on multiple computers in order to concurrently service multiple requests, where the request load is divided among the computers in the cluster. Many computer operating systems or application execution environments such as is provided by the Java™ Virtual Machine (JVM) periodically perform maintenance tasks, such as memory management using “garbage collection” techniques, during which time their applications cannot service requests. Although such maintenance-related delays might only last a few hundred milliseconds, even relatively short delays of this order are a problem for real-time applications, such as in the telecommunications, finance/trading, and defense fields, where delays in servicing applications that last hundreds of milliseconds or more are intolerable.

### SUMMARY OF THE INVENTION

The present invention in embodiments thereof discloses novel systems and methods for proactive prevention of service level degradation during maintenance in a clustered computing environment.

In one aspect of the invention a clustered computing environment with application staging is provided, including a plurality of application instances running on at least one computer and operating in a clustered computing environment, and a stage manager operative to manage the transition of any of the application instances between a front stage assignment and a back stage assignment, where any of the application instances that are assigned as front stage application instances service requests, and where any of the application instances that are assigned as back stage application instances ceases to service requests and performs at least one maintenance task.

### BRIEF DESCRIPTION OF THE DRAWINGS

The present invention in embodiments thereof will be understood and appreciated more fully from the following detailed description taken in conjunction with the appended drawings in which:

FIG. 1 is a simplified conceptual illustration of a clustered computing environment with application staging, constructed and operative in accordance with an embodiment of the invention;

FIG. 2 is a simplified flowchart illustration of an exemplary method of operation of the system of FIG. 1, operative in accordance with an embodiment of the invention;

FIG. 3 is a simplified flowchart illustration of a method for assigning an application instance to the back stage, operative in accordance with an embodiment of the invention; and

FIG. 4 is a simplified flowchart illustration of a method for returning an application instance to the front stage, operative in accordance with an embodiment of the invention.

### DETAILED DESCRIPTION OF THE INVENTION

The present invention is now described within the context of one or more embodiments, although the description is intended to be illustrative of the invention as a whole, and is not to be construed as limiting the invention to the embodiments shown. It is appreciated that various modifications may occur to those skilled in the art that, while not specifically shown herein, are nevertheless within the true spirit and scope of the invention.

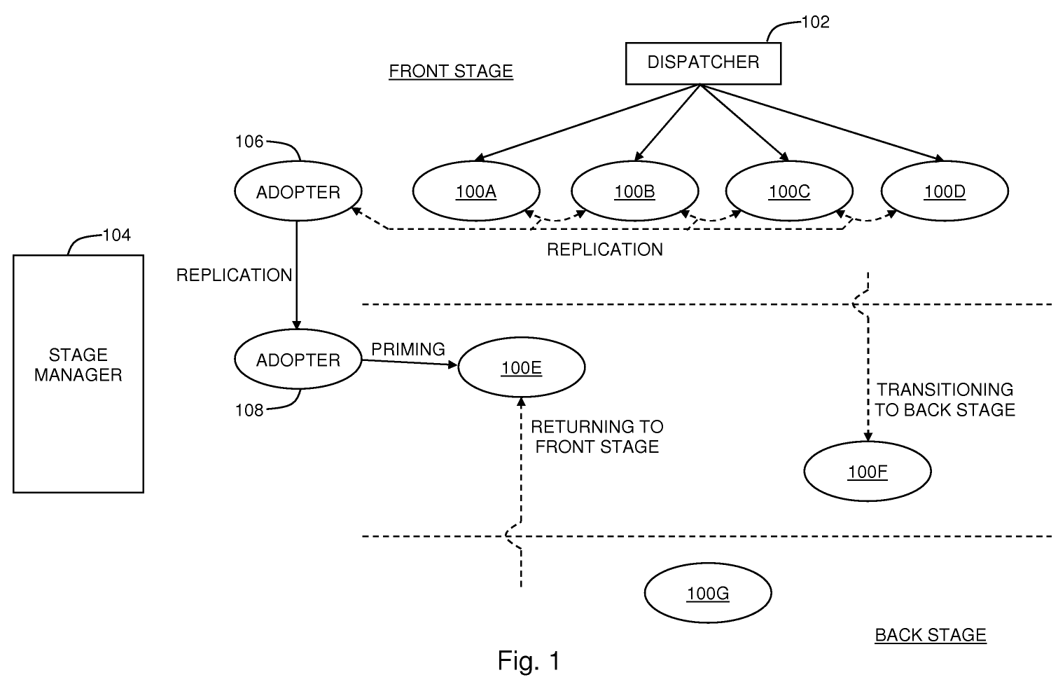

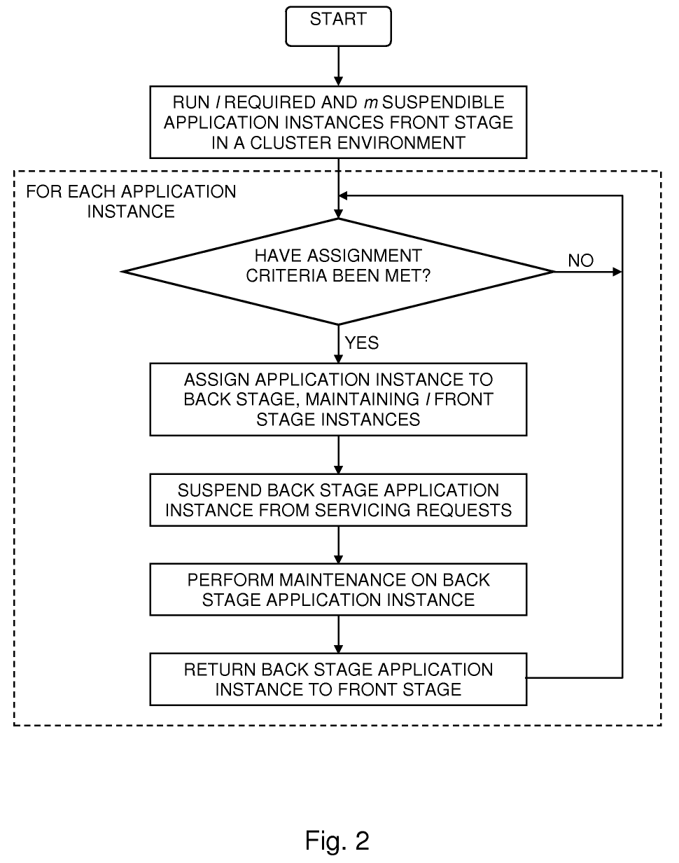

Reference is now made to FIG. 1, which is a simplified conceptual illustration of a clustered computing environment with application staging, constructed and operative in accordance with an embodiment of the invention, and additionally to FIG. 2, which is a simplified flowchart illustration of an exemplary method of operation of the system of FIG. 1, operative in accordance with an embodiment of the invention. In the system of FIG. 1 and method of FIG. 2, a number of instances of an application, such as application instances 100A-100G running on one or more computers, are shown operating in a clustered computing environment, such as where each application instance services requests that it receives from a dispatcher 102. The number of instances n includes 1 instances that are required to service a user-defined request load at a user-defined service level, in addition to m instances which may be temporarily suspended while the instances' execution environments perform maintenance tasks, such as memory garbage collection, software upgrades, etc., where maintenance may be initiated by the administrator, the program itself, or some external management component.

A stage manager 104 is provided for assigning any application instance as “front stage” or “back stage”, and for managing the transition of application instances between front stage and back stage. When an application instance is at front stage it services requests and performs no memory management and/or other maintenance tasks that would delay or prevent the application instance from servicing requests. In FIG. 1 application instances 100A, 100B, 100C, and 100D are shown having been assigned by stage manager 104 as front stage application instances. When an application instance is at back stage, it ceases to service requests and performs any required maintenance tasks, after which the application instance is returned to the front stage. In FIG. 1 application instance 100G is shown having been assigned by stage manager 104 as a back stage application instance, while application instance 100F is shown being transitioned by stage manager 104 from the front stage to the back stage, and application instance 100E is shown being transitioned by stage manager 104 from the back stage to the front stage.

Application instances in the cluster are periodically assigned by stage manager 104 to either the front stage or the back stage while ensuring that at any given time there are a sufficient number of front stage application instances to service the request load at the required service level. Stage manager 104 preferably assigns an application instance to the back stage when one or more predefined assignment criteria are met by the application instance or its execution environment. One example of this is when an application instance has been at front stage for a predefined period of time. Another example of this is when a performance measure reaches a predefined value, such as when the heap memory of the application instance's execution environment reaches a predefined allocation threshold. Stage manager 104 may assign an application instance to the back stage sooner, and return the application instance to front stage that much earlier, if it determines that one or more other application instances in the cluster meet a predefined proximity criterion indicating that they are about to meet their assignment criteria, and if doing so would ensure that the required service level will be maintained when those application instances are assigned to the back stage. For example, if an application instance meets its assignment criteria when its heap memory is 80% allocated, a proximity criterion may be defined that is met when its heap memory is 70% allocated. The assignment criteria may change dynamically during the cluster lifecycle. For instance, external anticipated load changes or other events may affect the assignment criteria, and cause application instances to be assigned to the back staged earlier or later. The number of application instances n is preferably set such that 1 application instances are available at any given time to service requests given the frequency of suspending instances while performing maintenance tasks and the duration of the maintenance tasks.

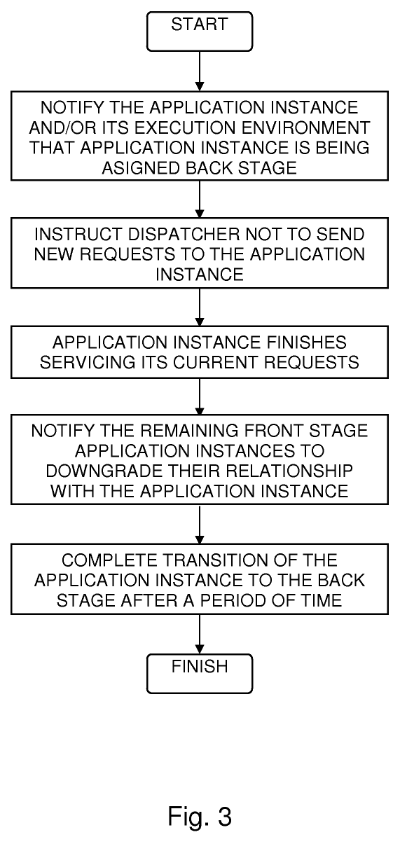

Additional reference is now made to FIG. 3, which is a simplified flowchart illustration of a method for assigning an application instance to the back stage, operative in accordance with an embodiment of the invention. Where the application instances in a cluster communicate with each other, such as for heartbeating, replicating state information and/or other data among themselves in support of failover operations, or performing group management tasks relating to the formation of new group views as member application instances join and leave the cluster group, the impact that the removal of an application instance from the front stage may have on the ability of the remaining front stage application instances to service requests at the required service level may be minimized by gradually removing the application instance from the front stage as follows. In the method of FIG. 3, once stage manager 104 decides to assign an application instance to the back stage it preferably notifies the application instance and/or its execution environment of the decision and instructs dispatcher 102 not to send any new requests to the application instance. The application instance then finishes servicing its current requests. Either stage manager 104, the application instance, or its execution environment notifies the remaining front stage application instances in the cluster to downgrade their relationship with the application instance. Consequently, other application instances can delay, cease, or decrease the sensitivity of their heartbeating with respect to the subject application instance. Similarly, they can cease to send messages to the subject application instance after a predefined period of time has elapsed. In addition, other application instances can classify as “gossip” or as “diagnostic” any non-essential messages that they send to the subject application instance, and as such, they do not have to expect responses to their messages. Non-essential messages sent from the downgraded application instance to the remaining front stage application instances may likewise be classified as “gossip” or as “diagnostic”. The transition of the application instance to the back stage may then be completed after a predefined period of time has elapsed.

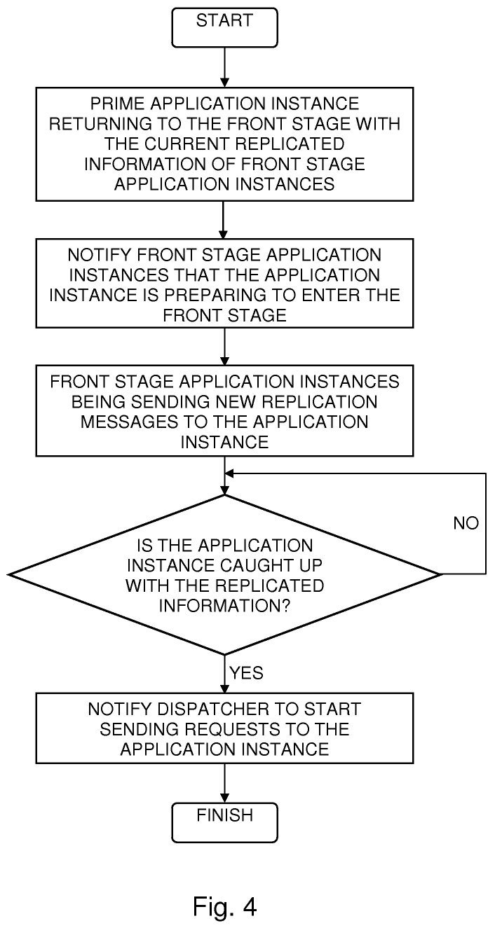

Additional reference is now made to FIG. 4, which is a simplified flowchart illustration of a method for returning an application instance to the front stage, operative in accordance with an embodiment of the invention. In the method of FIG. 4, where the front stage application instances replicate state information and/or other data among themselves, an application instance returning to the front stage is preferably resynchronized by priming it with the current replicated data, such as replicated state information and/or other replicated data, of the other front stage application instances. This is preferably not performed by receiving the replicated information directly from the other front stage application instances themselves so as not to degrade their ability to maintain the required service level. Rather, this is preferably performed by using a copy of the replicated information from a source other than the front stage application instances. Either stage manager 104, the application instance, or its execution environment notifies the other front stage application instances in the cluster that the application instance is preparing to enter the front stage. The other front stage application instances preferably include the application instance in their communications with each other, including sending new replication messages to the application instance. Once the application instance is fully caught up with replicated information, stage manager 104, the application instance or its execution environment notifies dispatcher 102 to start sending requests to the application instance, marking its full return to the front stage.

A “sync window” may be defined to be the set of the messages that arrived at the servers in the cluster, but that were not yet applied to the joining member. Any known method for resynchronizing a joining member of a cluster with the other members of the cluster may be employed, where resynchronization is preferably achieved when the joining member has all of the messages needed to apply any remaining changes to the local state (e.g., by replaying the operations encapsulated in those messages), and when its sync window is sufficiently small. In one approach, when this window is sufficiently small, additional incoming messages are blocked. The joining member then finishes applying any remaining changes. When it is finished, the other servers in the cluster are notified, and the incoming messages are unblocked. In another approach, when the sync window is sufficiently small, all the servers in the cluster and the request dispatcher are notified that the member has joined the group. While the joining member may receive the same message from multiple servers, it should have a filtering mechanism to avoid duplication.

An application instance returning to the front stage may be primed with the current state information of the other front stage application instances by receiving the current state information from an adopter 106 which “adopts” the application instance during its reentry into the front stage. Adopter 106 may be a front stage application instance that does not service requests but rather is dedicated to the task of priming application instances returning to the front stage, and therefore continuously receives replicated state/data updates from the other front stage application instances for this purpose. Adopter 106 may have a backup adopter 108 that can assume the adopter role in case adopter 106 fails, and in which case adopter 108 may prime and synchronize another application instance to serve as its backup adopter. Adopters 106 and 108 may themselves require periodic maintenance, and therefore the role of adopter may be alternated among various front stage application instances, where front stage application instances are assigned to the adopter role and subsequently returned to the front stage using techniques described hereinabove for transitioning application instances to and from the front stage. As the role of an adopter during priming may be intensive, stage manager 104 preferably notifies any cluster failure detection mechanisms to ignore or be less time-sensitive about heartbeat timeouts of the adopter.

In environments where replication updates are large and frequent a multi-level adopter mechanism may be employed to prevent the slow-down of communications among front-stage application instances if the adopter does not keep up with the pace of replication messages and acknowledgements in addition to its priming and heartbeating duties. In such a mechanism, for example, adopter 106 acts as a high-level adopter that is dedicated to replication communications and does not prime application instances returning to the front stage. Adopter 106 relays replication updates to adopter 108 which acts as a low-level adopter that primes application instances returning to the front stage, but that may be relieved of administrative communications tasks related to heartbeating or acknowledging receipt of replication messages with respect to the other front stage application instances. Additional levels of adopters may also be employed between the high-level and low-level adopters. Each intermediate adopter receives updates from a higher level adopter and feeds these updates to a lower level adopter. The updates from a higher level adopter to an intermediate adopter, and the updates from an intermediate adopter to a lower level adopter, may be performed synchronously or asynchronously. In addition, the update synchrony between any two levels of adopters may change during the front-staging process.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

What is claimed is:

1. A clustered computing environment with application staging, comprising:
a plurality of application instances running on at least one computer and operating in a clustered computing environment; and
a stage manager operative to manage the transition of any of said application instances between a front stage assignment and a back stage assignment,
wherein any of said application instances that are assigned as front stage application instances service requests, and
wherein any of said application instances that are assigned as back stage application instances ceases to service requests and performs at least one maintenance task.

2. The clustered computing environment according to claim 1 wherein said stage manager is operative to ensure that at any given time there are a sufficient number of said application instances that are assigned as front stage application instances to service a request load at a required service level.

3. The clustered computing environment according to claim 1 wherein said stage manager is operative to assign any of said application instances as back stage application instances when a predefined assignment criterion is met by said application instance.

4. The clustered computing environment according to claim 1 wherein said stage manager is operative to assign any of said application instances as back stage application instances when a predefined assignment criterion is met by the execution environment of said application instance.

5. The clustered computing environment according to claim 3 wherein said predefined assignment criterion is met when said application instance has been assigned as a front stage application instance for a predefined period of time.

6. The clustered computing environment according to claim 3 wherein said predefined assignment criterion is met when a performance measure of said application instance reaches a predefined value.

7. The clustered computing environment according to claim 4 wherein said predefined assignment criterion is met when heap memory of said execution environment reaches a predefined allocation threshold.

8. The clustered computing environment according to claim 2 wherein said stage manager is operative to assign any of said application instances as back stage application instances when at least one other of said application instances meets a predefined proximity criterion indicating that it is about to meet a predefined assignment criterion, and if doing so would ensure that said required service level will be maintained when said other application instance is assigned as a back stage application instance.

9. A method for assigning an application instance as a back stage application instance, the method comprising:
sending a notification that a front stage application instance in a clustered computing environment is to be assigned as a back stage application instance;
withholding any new requests from said application instance;
allowing said application instance to finish servicing its current requests;
notifying any remaining front stage application instances in said cluster to downgrade their relationship with said application instance; and
assigning said application instance as a back stage application instance after a predefined period of time has elapsed.

10. The method according to claim 9 wherein said downgrading of said relationship comprises delaying, ceasing, or decreasing the sensitivity of heartbeating with respect to said application instance being assigned as a back stage application instance.

11. The method according to claim 9 wherein said downgrading of said relationship comprises ceasing after a predefined period of time has elapsed to send messages to said application instance being assigned as a back stage application instance.

12. The method according to claim 9 wherein said downgrading of said relationship comprises classifying as “gossip” or as “diagnostic” any non-essential messages that are to be sent to said application instance being assigned as a back stage application instance that they send to the subject application instance.

13. The method according to claim 9 and further comprising classifying as “gossip” or as “diagnostic” any non-essential messages that are to be sent from said application instance being assigned as a back stage application instance to any of said remaining front stage application instances.

14. A method for assigning an application instance as a front stage application instance, the method comprising:
priming a joining application instance that is to be assigned as a front stage application instance with current replicated data of any current front stage application instances in a clustered computing environment;
notifying any of said current front stage application instances that said joining application instance is to be assigned as a front stage application instance;
including said joining application instance application instance in communications with any of said current front stage application instances;
sending new replication messages to said joining application instance once said joining application instance is fully primed with said replicated data.

15. The method according to claim 14 wherein said priming step comprises priming with current replicated state information of any of said current front stage application instances.

16. The method according to claim 14 wherein said priming step comprises priming using a copy of said current replicated data information from a source other than any of said current front stage application instances.

17. The method according to claim 16 and further comprising providing an adopter that continuously receives said current replicated data from any of said current front stage application instances and is dedicated to the task of priming application instances joining said front stage, and wherein said priming step comprises priming where said source is said adopter.

18. The method according to claim 17 and further comprising providing a backup adopter operative to assume the role of said adopter if said adopter fails.

19. The method according to claim 16 and further comprising:
providing a high-level adopter that continuously receives said current replicated data from any of said current front stage application instances; and
providing a low-level adopter that receives said replication data from said high-level and is dedicated to the task of priming application instances joining said front stage,
wherein said priming step comprises priming where said source is said low-level adopter.
